(19) United States
(12) Patent Application Publication
(10) Pub. No.: US 2017/0159345 A1
(43) Pub. Date: Jun. 8, 2017

(54) ENCLOSURE FOR A DRIVE UNIT OF A GARAGE DOOR DRIVE

(71) Applicant: NOVOFERM TORMATIC GMBH, Dortmund (DE)

(72) Inventors: Michael GLANZ, Langenfeld (DE); Michael HAMACHER, Ennepetal (DE); Jonas DEICKE, Dortmund (DE); Ulrich THEILE, Hagen (DE)

(21) Appl. No.: 15/125,404

(22) PCT Filed: Jun. 13, 2015
(86) PCT No.: PCT/EP2015/001204

§ 371 Date: Sep. 12, 2016

(30) Foreign Application Priority Data
Jun. 16, 2014 (DE) 10 2014 008 544.9
Feb. 9, 2015 (DE) 20 2015 000 922.0
Mar. 18, 2015 (DE) 10 2015 003 396.4
Mar. 18, 2015 (DE) 10 2015 003 397.2
Mar. 31, 2015 (DE) 10 2015 004 080.4

(51) Int. Cl. E05F 15/668; F21V 3/04; F21V 7/00; F21V 8/00

(52) U.S. Cl. CPC E05F 15/668; G02B 6/001; F21V 3/0436; F21V 7/00; E05F 15/681

(57) ABSTRACT

The invention relates to an enclosure for a drive unit (1) for the automation of a garage door, wherein the drive unit (1) includes a connection to a drive track (4), which is provided with revolving force transmitting means (19), the enclosure as a two-part housing consists of a lower housing part (2) and an upper housing part (32, 54), wherein the lower housing part (2) includes a straight planar housing underside (37) the border areas (15) thereof being provided with roundings (8) and thereto adjoining essentially straight lateral sections (9), and in that the upper housing part (32, 54) is fitted onto the lateral sections (9), wherein the exterior contour includes transitions (11), which are configured as curved extensions, which merge into a straight housing back side (7), which is configured essentially parallel to the housing underside (37), wherein the surface content of the housing back side (7) is smaller than the surface content of the housing underside (37).

The invention relates to an enclosure of a drive unit, which is employed for the automation of a garage door drive. A drive track is in connection with a drive unit, in which drive track revolving force transmitting means, which are driven by means of the drive unit and is connected to the garage door, are in connection. Such drive units are also referred to as ceiling tractors.

The document DE 20 309 496 U1 discloses a motor-driven apparatus for opening and closing a door. In this case, the apparatus consists of a drive head, which is composed of a control unit, a frequency converter, a motor and a transmission unit, as well as of a drive track, which includes a running carriage. The drive track is configured as a pluggable construction assembly unit, wherein the entire transmission is disposed in the drive track.

For illuminating the inside of a garage or the like, garage door drive devices are equipped with illumination apparatuses. In this case, the document DE 20 2004 018 115 U1 discloses electrical light bulbs, which are disposed next to the garage door drive.

In the document DE 20 2005 000 349 U1 light-emitting diodes are employed in part of the housing of the garage door drive.

The document DE 20 2005 000 590 U1 reveals an illumination system for door drives, which are incorporated into a housing for the door drive, and electric spotlights are utilized as lighting means. In this case, light-emitting diodes in the shape of individual lighting diodes and also in the shape of lighting diode clusters are employed. In addition to the purpose of pure lighting, on account of the high-frequency timing, the lighting means are able to emit commands to other visually reachable command elements. In this case, in addition to the light-permeable area of the hood, which serves for illuminating the room, at least one further light-permeable area is provided, by means of which the clocked light can be uncoupled by means of a light guide and conducted to a light-permeable area of the hood.

Illumination apparatuses, respectively illumination modules in different configurations are revealed in the documents DE 20 2013 103 294 U1, DE 20 2011 050 596 U1 as well as DE 20 2011 050 253 U1.

The drive units available on the market today based on their housing have a very large, bulky built external shaping. In this case, in particular illumination apparatuses are configured to protrude from the housing shape. Such a housing considerably restricts the clearance height within buildings, in which the drive device is mounted in a suspended manner below the ceiling.

The document DE 20 2007 014 554 U1 reveals a door drive, the housing thereof being configured in two parts. Said housing includes a reception for a socket or for a traction relief. In this case, the socket has a socket body, which projects protruding from an opening in the exterior wall of the housing.

The object of the invention is to configure an enclosure, i.e. a housing for a drive unit of a garage door drive in such a manner that the exterior dimensions of the drive unit, in particular in the height, are considerably reduced with regard to the known state-of-the-art. Furthermore, structural components, such as in particular illumination apparatuses and a connection to a drive track, should not be disposed as protruding from the enclosure, because damages are always caused by such protruding parts. Furthermore, all built-up structural components reduce the installation height, whereas all functional areas of the drive unit should be kept. Such a drive unit should be suitable for the most different installation situations.

This problem is solved by the characteristics of patent claim 1. In this context the dependent claims represent another configuration of the inventive idea.

The inventive enclosure of the drive unit for a garage door drive is configured as a two-part housing with a lower housing part and an upper housing part. In this case, in the installed condition, the lower housing part is directed to the floor of the building and includes an essentially planar housing underside. Herein, all projecting parts or devices are foregone, with the intention to eliminate damages of individual housing parts. The border area of the lower housing part includes circumferential roundings or other organic shapes, which subsequently and essentially merge into straight lateral sections. The separation between the lower housing part and the upper housing part is made in the area of the straight lateral sections. Thus, the upper housing part likewise has straight lateral sections in the shape of borders, by means of which mounting the enclosure, which consists of the lower housing part and the upper housing part, is possible without using any tools. The circumferential borders of the upper housing part, in an exterior contour while forming curved extensions or slants, merge into a straight housing back side of the upper housing part. In this case, the housing back side is configured essentially parallel to the housing underside. As revealed in the description, the configuration of such an enclosure for a drive unit is realized without any projecting parts. Essentially, the basic shape of the enclosure consists of a geometrical shape, which may include a rectangular or a square configuration.

Laterally configured radii and curved extensions or slants provide for a harmonious housing shape. In this case, the straight housing back side presents a smaller surface content than the straight housing underside. When compared to the state-of-the-art, practically, such a design allows the viewer to perceive the drive unit as a dematerialized enclosure. Said organic styling makes the enclosure visually appear to be considerably smaller in the height extension thereof.

The circumferential roundings or a similar configuration connecting to the planar straight housing underside are simultaneously utilized for accommodating here a circumferential or partially circumferential light band behind a translucent covering. In this configuration again, the protrusions, which are usually found in drive housings, are omitted.

In one preferred embodiment, the illumination apparatus thereby may fill the entire underside and is executed by utilizing light-emitting diodes or similar devices. Said diodes may illuminate the entire surface or else only a portion of the surface and harmoniously integrate with the realized enclosure shape. In this case, the illumination apparatus, located in the circumferential band may be employed for the most various situations. Thus, the illumination apparatus may be operated for example in different colour spectra. Thereby, the different colours of the illumination may be employed altogether for certain operations at and in conjunction with the garage door and the garage.

With the intention to even assist the pleasing housing of such an enclosure for the drive unit even more, the exterior transitions between the individual enclosure sections, respectively areas are always configured step-less, meaning sharp edges are omitted.

In a further preferred embodiment, it is likewise possible that, starting at the straight lateral sections, curved extensions or slants of the upper housing part are adjoined, which do not extend as far as to the straight housing back side.

Simultaneously, the housing back side may be a part of the mounting base, to which the components, which are contained inside the drive unit, are completely or at least partially attached. The attachment may be realized for example by means of latching connections of the individual structural components directly inside the upper housing part. Simultaneously, the mounting base may as well include a connecting area for the drive track. The drive track is namely not fitted onto the upper housing part as usual in the state-of-the-art. Rather, the drive track is connected in a butt-shape manner to the drive unit at or via a frontal side and by means of an adjoining area in an exchangeable manner. Furthermore, attachments for the attachment to the ceiling may be incorporated at or in the mounting base.

In a further preferred embodiment, it is possible that the drive track be equipped with exchangeable and laterally disposed lateral parts, which are essentially configured in the overall width of the drive device connected to the latter. In this case, the housing underside may be realized in continuation of the lateral parts.

With the intention to realize such a pleasing enclosure for a drive apparatus, which includes all necessary apparatuses for a smooth operation, the dimensional width or length is a multiple of the height of the drive unit. As the housing underside presents for example a rectangular or square shape, simultaneously the drive unit may become more slender by increasing the length of the enclosure. In this case, the ratio of width to height of the enclosure may be essentially a ratio of approximately 1:5, whereby other ratios are possible.

Such an enclosure of the drive unit may be realized in an inexpensive manner from plastic material or light metal in an injection moulding process. In this case, different colour configurations of the interconnected housing parts and also of the lateral parts of the drive track are possible.

The lower housing part may be optionally configured with an illumination apparatus, which as an illumination unit can be connected in an exchangeable manner to the upper housing part. In this case, such an illumination unit consists of a light-permeable, essentially planar and two-dimensionally configured radiation surface, behind which a reflector is disposed. In this case, the reflector with its incorporated light-emitting diodes having a long lifespan ensures a very homogenous illumination. The configuration of an integral light-permeable radiation surface achieves clarity and openness of the illumination unit and simultaneously of the enclosure as well.

The reflector may be for example delimited by an exterior surrounding frame and a radiation unit with light-emitting diodes may be placed at least at one side of the frame. Said radiation unit is activated by means of an electronic control contained within the drive unit. As the entire radiation surface consists for example of translucent plastic material, not only a partial surface illumination is created in front of the arrangement of the light-permeable configuration of the lower housing part, which contains the lighting means, but a large surface illumination, which extends over the entire underside of the drive unit. Preferably, the radiation surface is connected to the reflector in an exchangeable manner via the frame.

In addition to a configuration with light-emitting diodes, also a light guide may be employed for generating the light radiation. Transparent structural elements are referred to as light guides, which at their border surfaces and via reflections emit a total reflection to the surrounding medium, which total reflection is based on a lower refractive index. Such a light guide may be referred to as optical fibre as well. In this case, also planar light guide structures are applicable.

In addition to a two-dimensional homogenous illumination of the radiation surface, it is also possible that the utilization of an additional light guide generates an atmosphere of relaxation by means of combining colour and light. Based on individual sensations of well-being, a custom-tailored additional illumination apparatus is created. This can be achieved in that an additional light guide or a light band is placed at the edges of the radiation surface. Electric energy supply may be realized from the same radiation unit or from a separate radiation unit. In this case, the illumination colour in different colour spectra should be preferably realized in a blue range. In such an embodiment, the illumination unit may form so to say the entire lower housing part and thus serve as the closure for the enclosure with the upper housing part. When employed in said variant, the entire existing surface of the drive unit radiates downwards to the floor of the building.

In a further preferred embodiment, it is possible that electronics, which in addition to displays also include push-buttons, be provided within the radiation surface. Said arrangement may be embodied in a preferred embodiment by means of a transparent printed execution. Such push-buttons may be incorporated into the radiation surface as capacitive push-buttons, which are preferably made from plastic material. Such an embodiment of displays or push-buttons, which may serve for manipulating or programming the drive unit, is linked to the electronic control of the drive unit via flexible electric connectors.

With the intention to enhance the value of the insignificant appearance of the drive track, a superior surface solution in the shape of a coloured design is chosen. Such a surface embodiment provides an up-valued aesthetical appearance to the drive track. In this case, individual customer specifications can be considered in that they select their own colours from an existing assortment, optionally for example from RAL-colours. Thereby, primarily a large decoration variety having different design elements is achieved. In addition to an embodiment in a varnished form, said elements may be embodied also in a powder coating. In this case, in particular mineral materials in pure white or black are of particular importance. Thus, elegant nuanced colour shades can be achieved. Said design nuances may range from the grey to the black spectrum. Dark brown or beige nuances produce a warm ambiance. With the coloured embodiment of the drive tracks not only unobtrusive, but also vibrant colour accents can be achieved by means of a colourful embodiment of the surface with strong colours, in addition to black-white contrasts.

In addition to the uniform coloured embodiment, also multi-facetted patterns are possible. In this case, said colour spectrum ranges from an almost white look via grey and light-brown nuances to punchy black shades. Such fine and uniform structures radiate calmness and elegance into the lateral surfaces and the ceiling surfaces and represent a successful alternative to the nature coloured light-metal embodiments, respectively the dull galvanized surfaces of known drive tracks.

In addition to the above-described embodiment of a coloured design by means of varnishing or powder coating or an electro-static procedure, it is also possible that the exterior surfaces or exterior parts of the drive unit are provided with film. Furthermore, the possibility of selecting a coloured design for the drive track is given in that they will achieve a harmonious overall appearance with the exterior colours of the enclosure of the drive unit.

Hereinafter, the invention will be explained in more detail on the basis of possible exemplary embodiments, which in the drawings are non-exhaustive diagrammatically illustrated.

In the drawings:

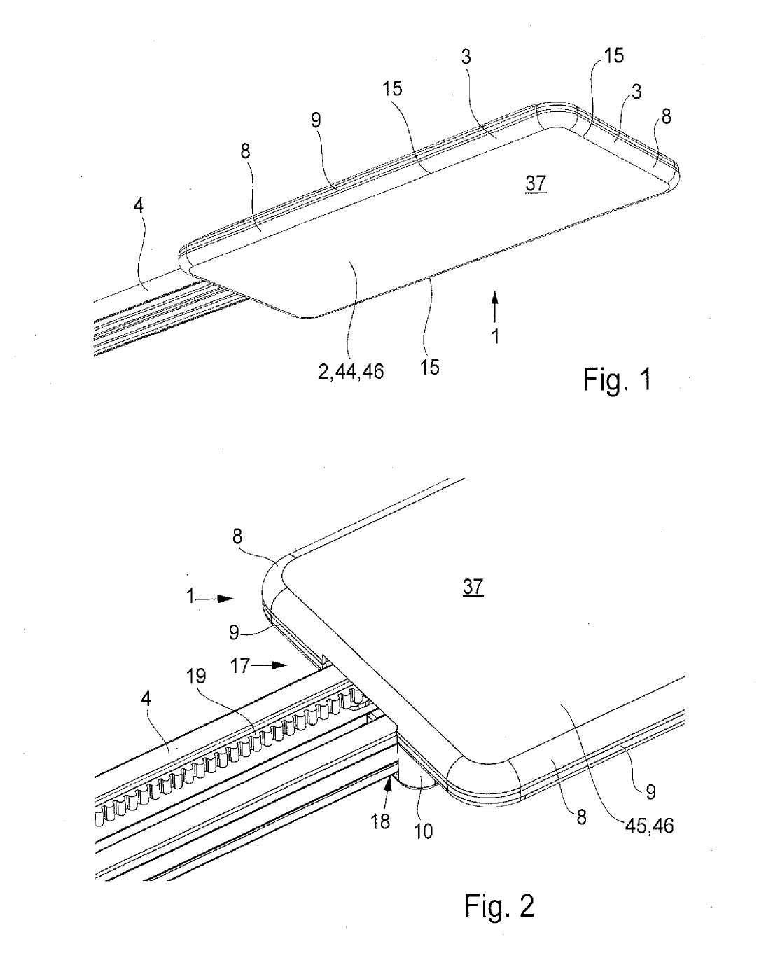

FIG. 1 shows a perspective illustration of a drive unit with a view on a housing underside of the enclosure thereof;

FIG. 2 shows a sectional illustration of the drive unit with the connected drive track;

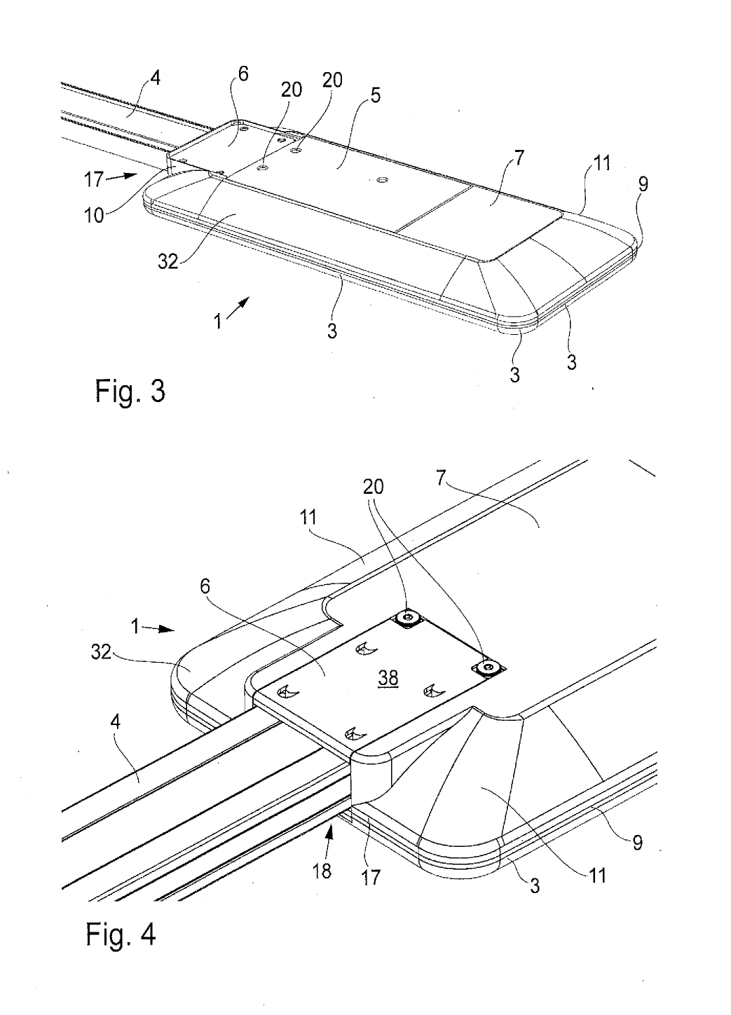

FIG. 3 shows the same as FIG. 1, however in a view from the backwards side;

FIG. 4 shows a backwards view of the drive unit with a drive track connection;

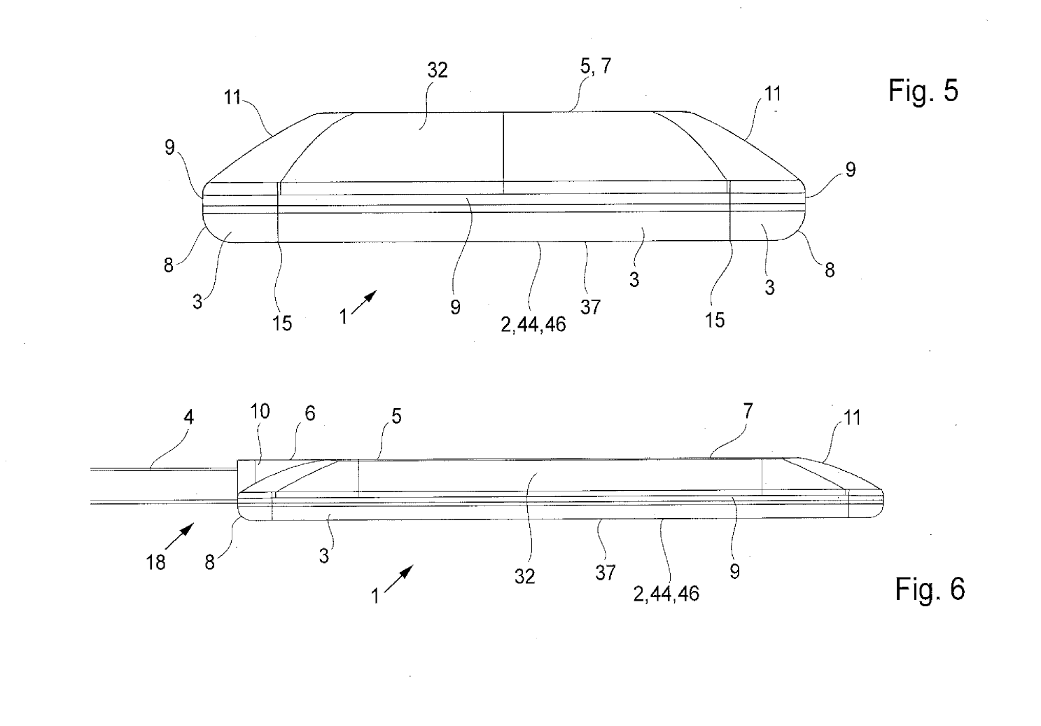

FIG. 5 shows a view of the end configuration of the enclosure;

FIG. 6 shows a lateral configuration of the enclosure with a connection to a drive track;

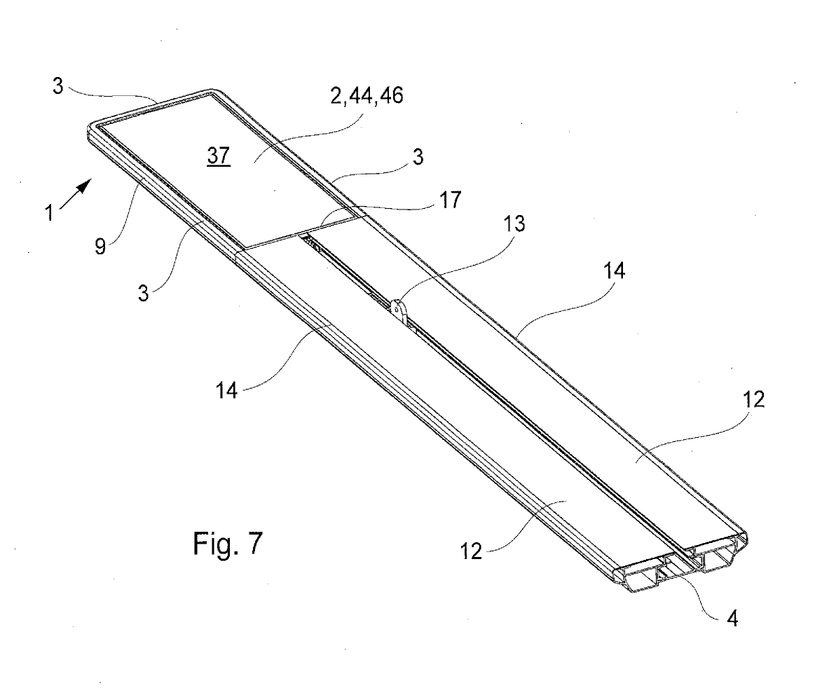

FIG. 7 shows a perspective illustration of the drive unit in connection with a drive track and the attached lateral parts, seen from the underside;

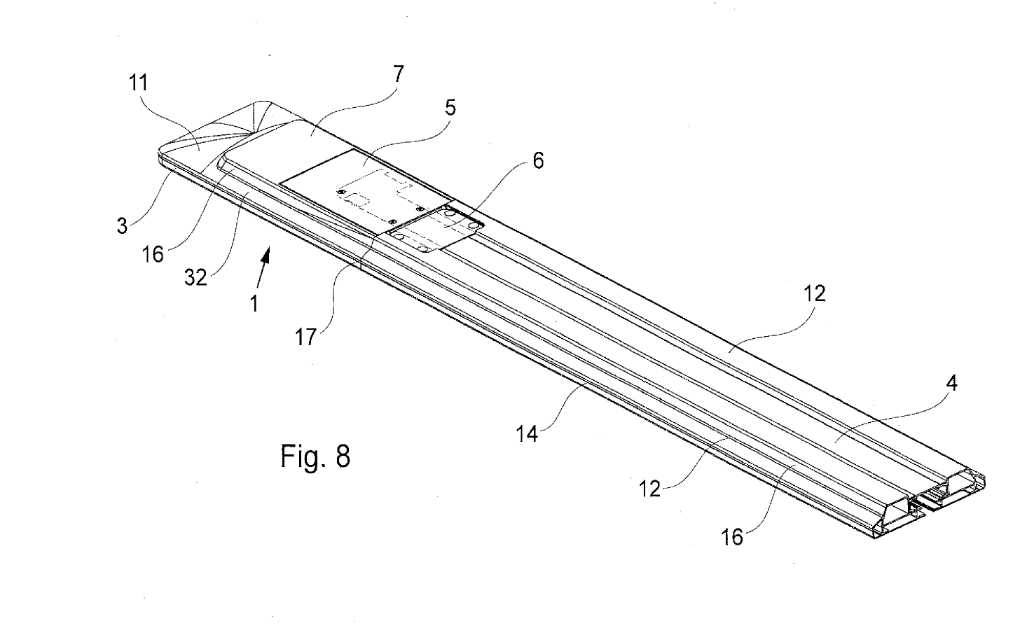

FIG. 8 shows the same as FIG. 7, however seen from the upper side

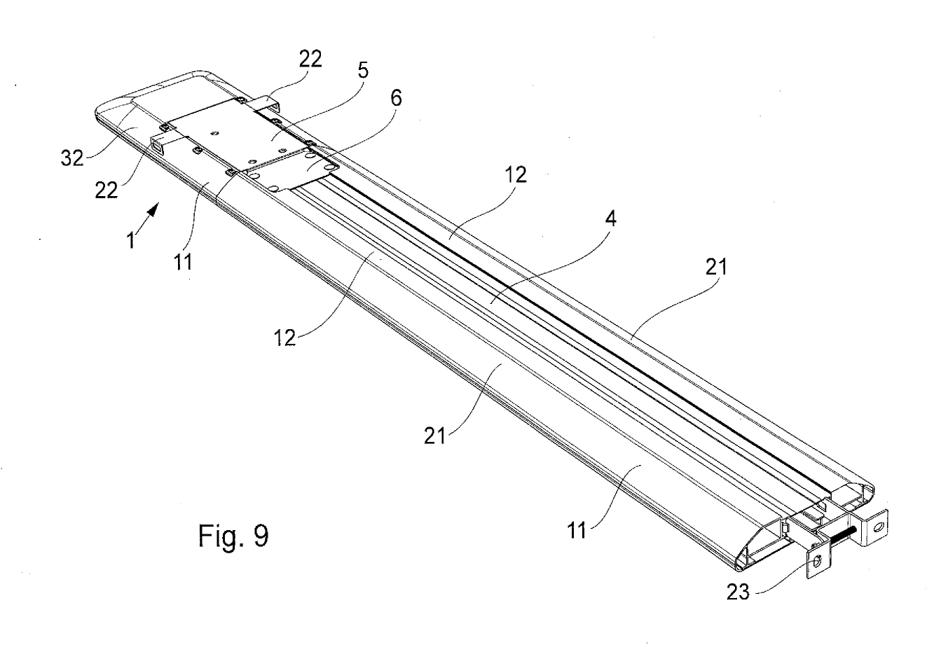

FIG. 9 shows the same as FIG. 8, however in a modified embodiment;

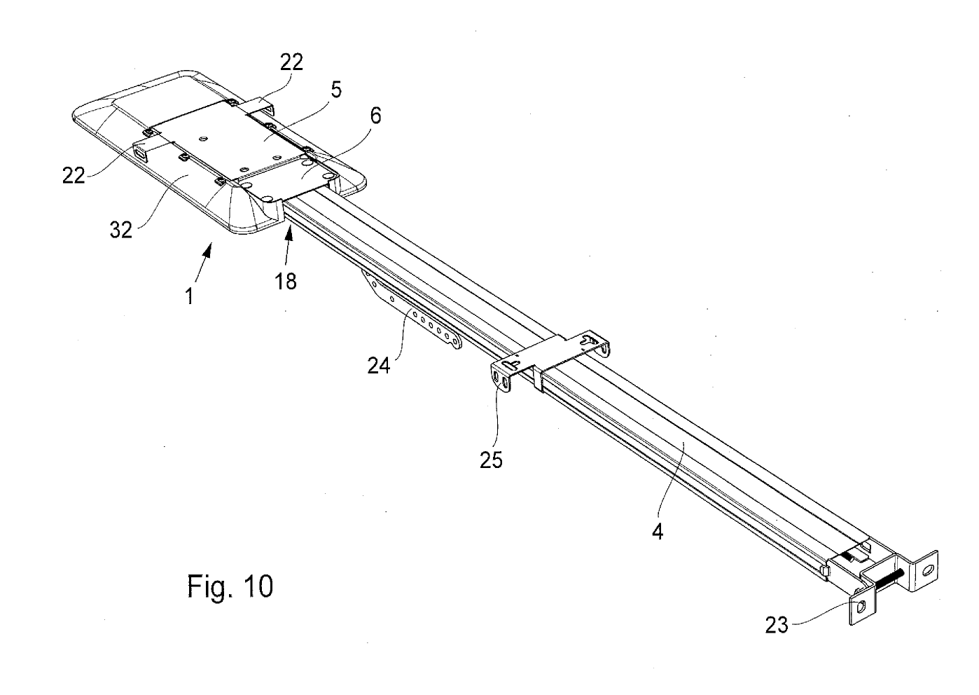

FIG. 10 shows the same as FIG. 9, however without lateral parts in a view from the upper side;

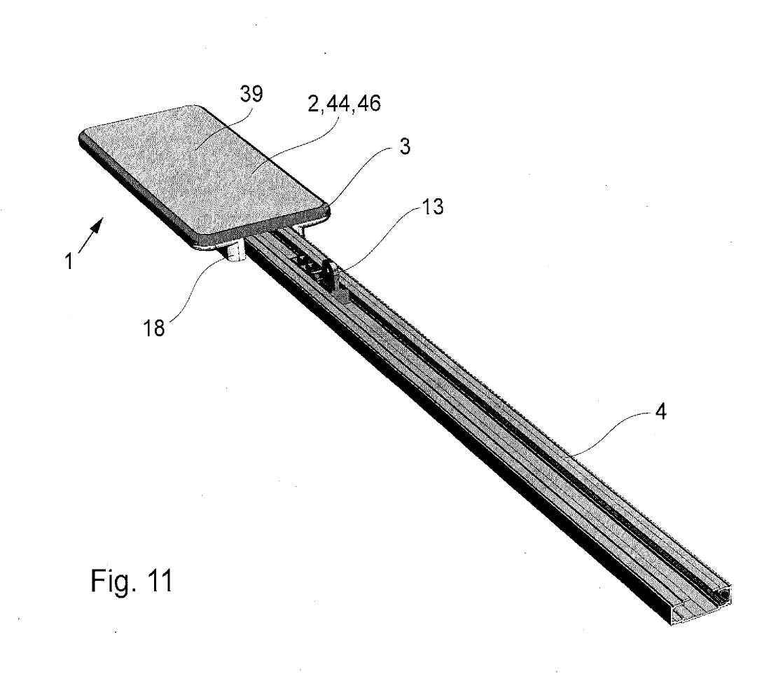

FIG. 11 shows the same as FIG. 10, however in a view from the underside;

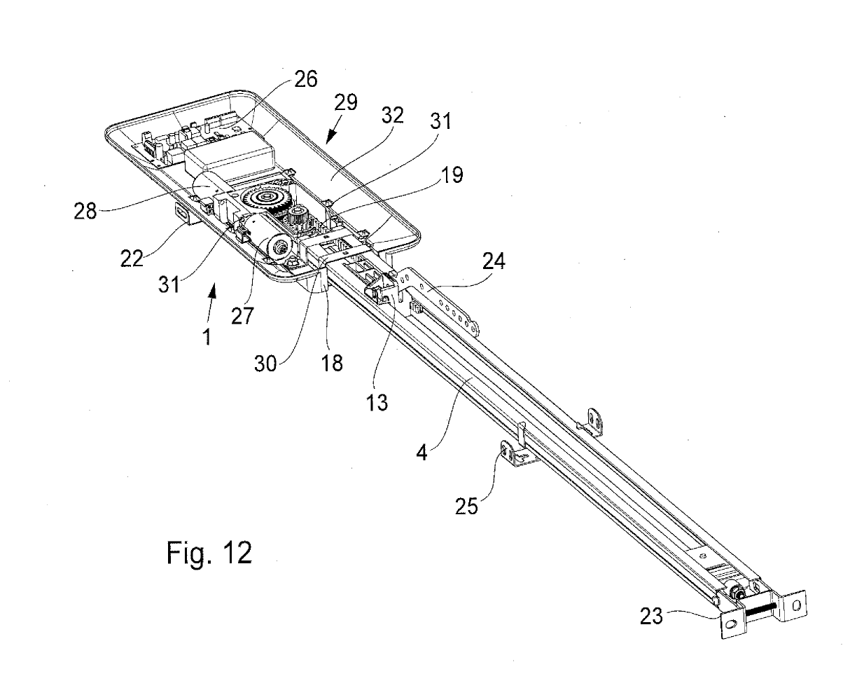

FIG. 12 shows a view on the drive unit, while omitting the lower housing part;

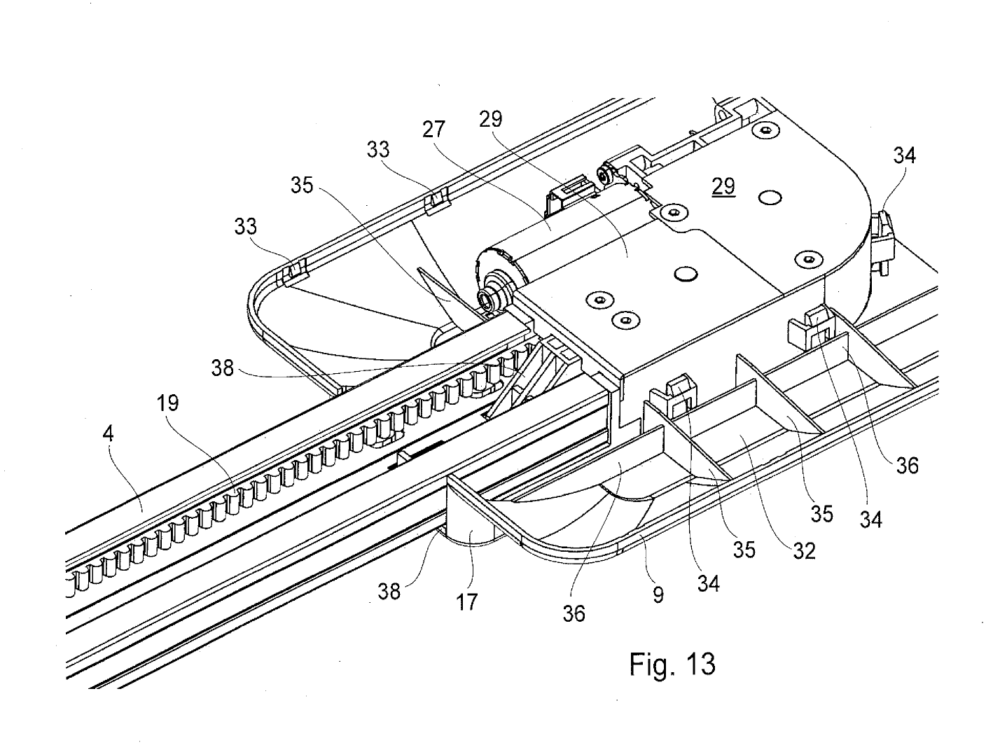

FIG. 13 shows the same as FIG. 12, however in a sectional illustration;

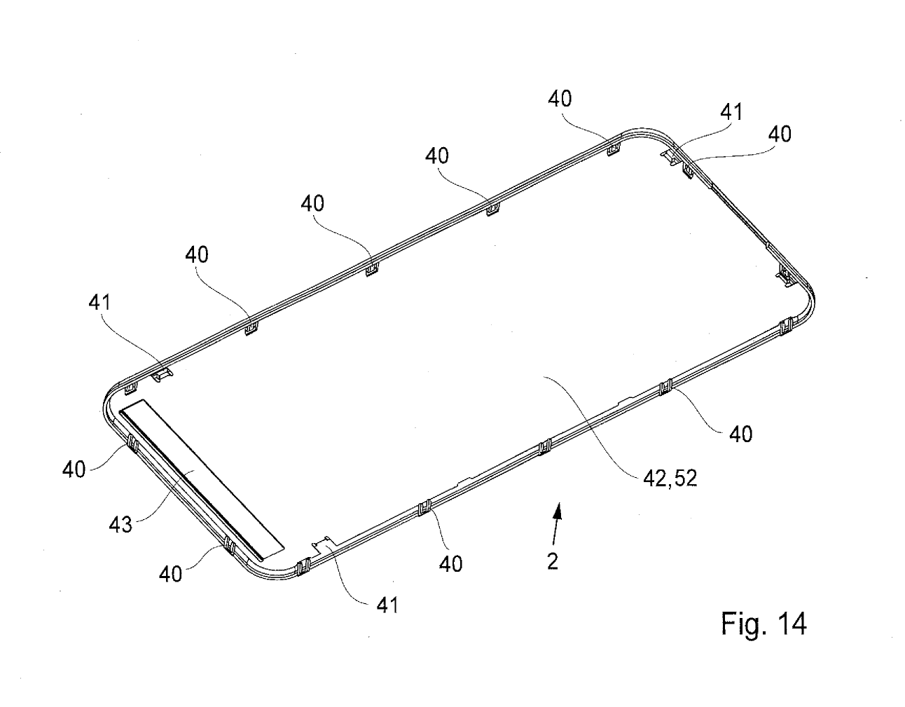

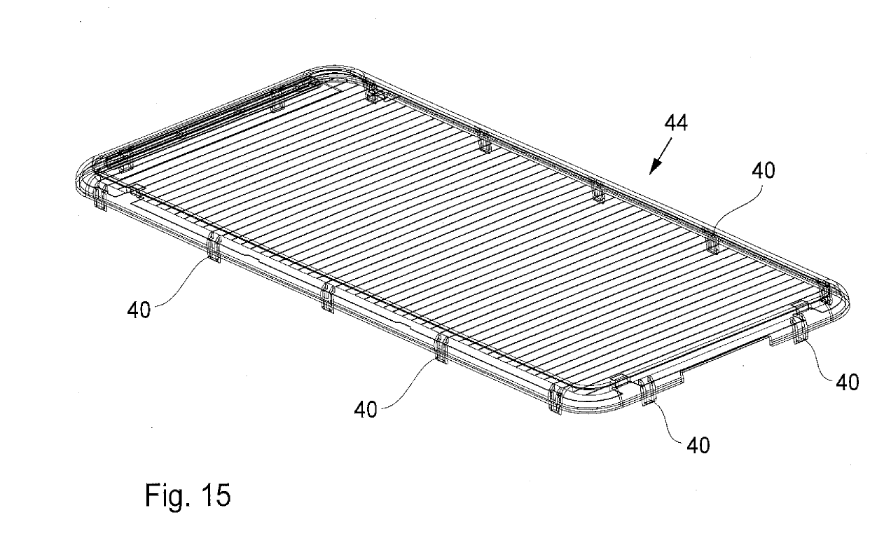

FIG. 14 shows a partial embodiment of the lower housing part in the area of the illumination apparatus;

FIG. 15 shows a cover for the lower housing part according to FIG. 14;

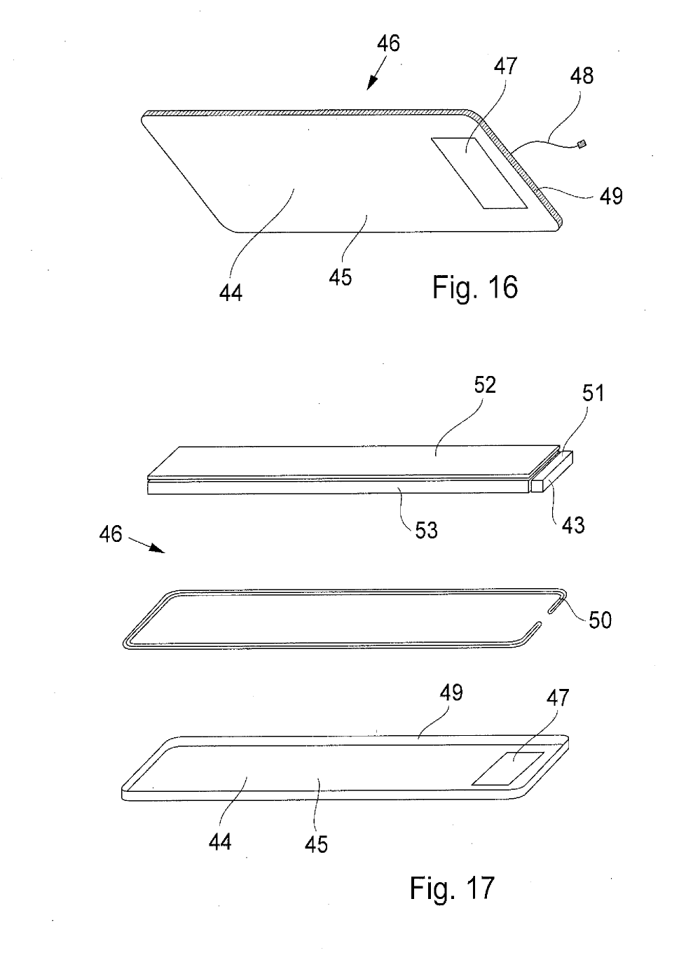

FIG. 16 shows a perspective illustration of an illumination unit;

FIG. 17 shows an exploded drawing with the important elements of the illumination unit according to FIG. 16;

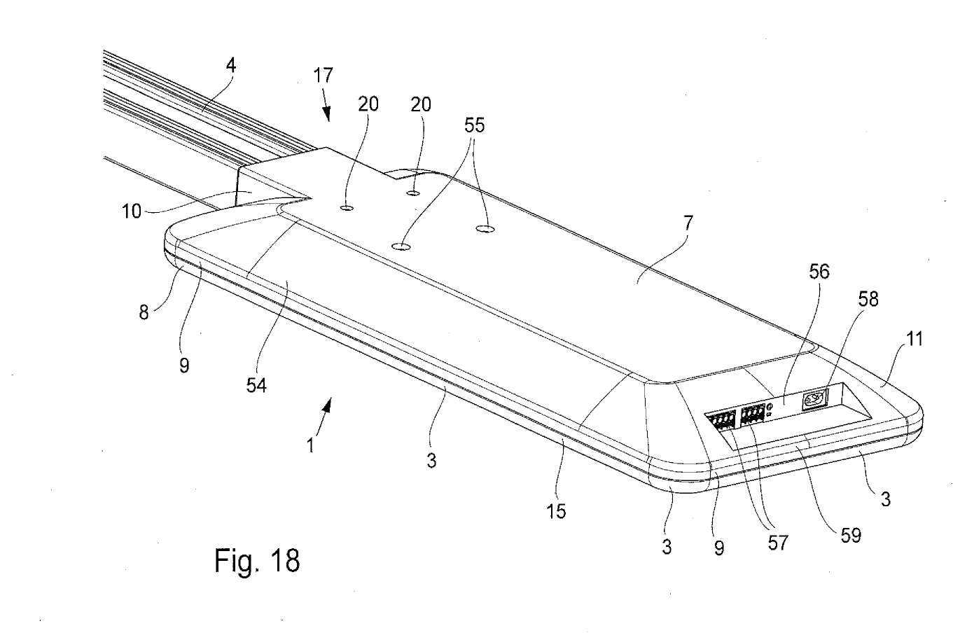

FIG. 18 shows a modified embodiment of the upper housing part;

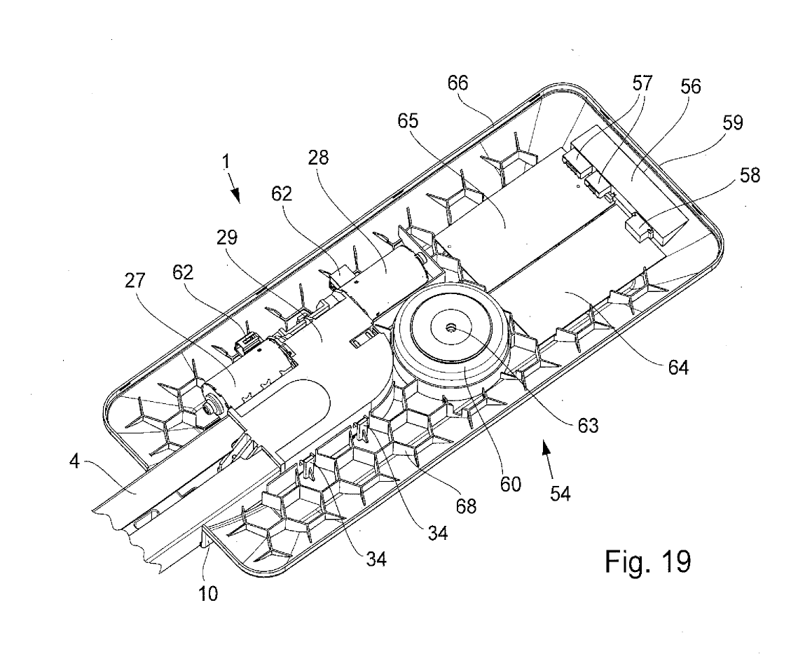

FIG. 19 shows a possible embodiment of the upper housing part with the inserted drive components.

In FIG. 1 a drive unit 1 is illustrated by means of the perspective 30 illustration from the underside, i.e. in a view on a housing underside 37. The housing underside 37 is represented as a smooth planar surface of a lower housing part 2. At its border areas 15, the smooth planar housing underside 37 is drawn upwards by means of roundings 8, wherein the roundings 8 merge into lateral sections 9. Essentially in this case, the lateral sections 9 are configured at a right angle with regard to the housing underside 37. The border area 15, which preferably surrounds the entire housing underside 37, is connected in its corner areas by means of radii. Simultaneously, the area of the roundings 8 may be configured as a circumferential or partially circumferential light band 3. Such a light band 3 may achieve a different light design, meaning that the illumination colour can be adapted in colour to the most various situations by means of a control unit 26 contained within the drive unit 1.

The harmonious configuration of the roundings 8 and of the adjoining lateral sections 9 is revealed in FIG. 2 in conjunction with an adjoining area 18, which is recessed at a frontal side 17, of an extension 10 for a drive track 4. Revolving force transmitting means 19, which may be configured as a toothed belt or as a chain and driven by the drive unit 1, are disposed within the drive track 4.

FIG. 3 represents the portion of the drive track 1 with the upper housing part 32 thereof. It becomes obvious that the lateral section 9 is harmoniously formed in a curved shape or in a slant of a transition 11, when assembling the two housing parts, namely the lower housing part 2 and the upper housing part 32. Said transition 11 extends as far as to a housing back side 7 of the upper housing part 32. In said preferred embodiment according to FIG. 3, a mounting base 5 is represented in a part of the backside 7. It is via the mounting base 5, which may even include an adjoining area 6, which is removable, that the drive track 4 is non-positively and positively connected to the drive unit 1, for example via screw connections 20. 30 This illustration also reveals that the design of the enclosure of the drive unit 1 does not include any protruding enclosure parts at all. This becomes also obvious at the connection of the drive track 4 via the extension 10. Said embodiment allows for a connection of the drive unit 4 via the frontal side 17 of the drive unit 1, which is realized without protruding housing parts, which however are necessary in the state-of-the-art.

FIG. 4 shows another preferred embodiment in a sectional illustration of the adjoining area 6 with a configuration of a linking part 38, which is connected to the drive unit 4, and which, via the screw connections 20, is connected to the housing back side 7, respectively to the mounting base 5 or to the structural components of the drive unit 1. Also said illustration reveals very well that the structural height of the present enclosure of the drive unit 1 has been reduced multiple times, when compared to the state-of-the-art.

This circumstance is again expressed in the illustration according to FIG. 5. Furthermore, herein the parallelism between the housing underside 37 and the housing back side 7 is revealed. Moreover, it is expressed again that by creating different radii, any sharp edges have been omitted for any parts of the individual enclosure areas. FIG. 5 also shows the transition from the housing underside 37 via the roundings 8 with the adjoining lateral sections 9, which, when assembling the lower housing part 2 and the upper housing part 32, do not form any sharp or protruding edges, such that the rounded transitions 11 are harmoniously continued from the lateral sections 9 and as far as to the housing back side 7. FIG. 5 also reveals that the configuration of the enclosure, on account of the lower housing part 2 in conjunction with the upper housing part 32, is a flat and slender unit of the drive unit 1, for which the state-of-the-art does not offer anything comparable, and this configuration is again expressed in the illustration of FIG. 6.

In a further preferred embodiment, it is possible that, for the drive unit 1 according to FIG. 7, the light band 3 has been realized on three sides only. At the frontal side 17, which is located in the area of the connection to the drive track 4, next to the drive track 4 an arrangement of lateral drive track lateral parts 12 on both sides left and right has been embodied next to the drive track 4. In this exemplary embodiment, said drive track lateral parts 12 include a further light band 14 in continuation of the light band 3 on each side in the longitudinal extension. In this embodiment, the configuration of the housing underside 37 with regard to the drive track lateral parts 12 has been uniformly realized. A catch member 13, which is connected to the revolving force transmitting means 19 in such a way that a motor of the drive unit 1 drives said force transmitting means 19, is illustrated in the central area of the drive track 4. A connection to a garage door by means of a connection lever 24 is ensured via the catch member 23 in a suitable manner. As furthermore revealed in the illustration, the drive track lateral parts 12 are configured in such a way that in the central area they form a passage for the catch member 13.

FIG. 8 represents a view from the rear end on such a configuration with the drive track lateral parts 12. In this case, this exemplary embodiment has been modified in that it includes an additional extension 16 between the transitions 11 and the housing back side 7 as well as the mounting base 5. However, for the viewer, said extension does not carry any weight, because the parallelism to the housing underside 37 is kept by means of the housing back side 7. Such a configuration allows for example to create more space within the enclosure without compromising the visual appearance. Herein again, the essential parallelism between the housing back side 7 and the housing underside 37 is kept as well. This can be achieved in that the border areas are realized somewhat narrower. For visual reasons, said extension 16 is also continued on the rear part of the drive track lateral parts 12 and here again has the effect of rendering the entire embodiment more slender.

A further preferred embodiment of a connection of the drive unit 1 to drive track lateral parts 12 disposed in the area of the frontal side of the drive track 4 is revealed in a modified embodiment of FIG. 9. In this embodiment, the transitions 11 directly merge into the flat part of the upper housing part 32, just as they merge into the drive track lateral parts 12. A lintel attachment 23 of the drive track 4 is illustrated at the end side of the drive track 4. Moreover, at the mounting base 5, the possibility of attachments 22 is illustrated on both sides of the drive unit 1. By means of said attachments 22 suitable suspensions, which are attached to a ceiling or to a profile, can be directly attached to the housing back side 7 or via the mounting base 5.

FIG. 10 illustrates the drive unit 1 in conjunction with the drive track 4 without the above described drive track lateral parts 12. Herein the universality of the drive unit 1 is illustrated, which can be operated both with and without the drive track lateral parts 12. In addition to the attachment 22 in the area of the drive unit 1, moreover a track attachment 25 is illustrated at the drive track 4. The drive track lateral parts 12 may be retrofitted as well.

While the illustration according to FIG. 10 illustrates the rear part of the drive unit 1, FIG. 11 illustrates the opposite part of the drive unit 1 with the drive track 4. After removing the lower housing part 2, a view into one possible embodiment of the drive unit is revealed according to FIG. 12. In this case, via the adjoining area 18, the drive track 4 has been inserted into the upper housing part 32 at the head end and is immobilized at that location for example by means of drive track attachments 30. Next to the drive track 4 is illustrated the configuration of a gearbox 29 without a cover. In this case, the force transmitting means 19 with a non-identified drive wheel engage in the gearbox arrangement. Motors 27 and 28 are connected to the gearbox 29. Herein, the possibility is given of optionally employing one or two motors 27, 28, as needed. The control unit 26 is located in the rear part of the upper housing part 32.

The attachment of the gearbox 29 is revealed in FIG. 12. In this case, drive parts, such as for example the gearbox 29 with the motor 27, are inserted in a simple way within the upper housing part 32 and are simultaneously immobilized therein via the attachments 34, which may be configured as latching connections. The illustration clearly reveals as well that the drive track 4 with the force transmitting means 19 included projects beyond the linking part 38 into the frontal area of the drive unit 1. The upper housing part 32 includes reinforcements 36 within the interior side thereof, which are configured for example as reinforcing ribs 35. As such a housing consists of plastic material or of light metal, said reinforcements 36 and reinforcing ribs 35 produce a higher stability against distortions. The lower housing part 2 is also connected to the upper housing part 32 by means of connections 33, which are configured as latched connections.

As revealed in the illustrated exemplary embodiments, which are non-exhaustive, the invention is in particular distinguished in that the drive track 4 is so to speak configured in continuation of the drive unit 1. The drive track 4, with or without the drive track lateral parts 12, is distinguished by a very slender configuration. Said illustration reveals that the drive track 4 is not connected to the drive unit 1 in the upper area. The present combination of the construction does not limit in any way the interior space of a garage or any other building part when placing the drive track 4.

FIG. 14 represents an embodiment of the lower housing part 2, in which in the entire area or in a partial area, the configuration of the lower housing part 2, respectively also of the entire lower housing part 2 is equipped with an illumination apparatus. The connection between the lower housing part 2 and the upper housing part 32 may be realized for example by means of clips connections 41. In this case, the lower housing part 2 consists essentially of a bottom 42, which is preferably configured as a reflector 52. A radiation unit 43 for emitting light rays is provided at least on one side. For example light-emitting diodes may be employed as a radiation unit 43. In this case, preferably the entire floor 42 may be provided with a light-enforcing respectively a light-reflecting coating or the like. The control unit 26 supplies electrical voltage to the radiation unit 43. As a closure for the reflector 52, a covering 44 may be employed, which is shown in FIG. 15. In this case, the connection between the lower housing part 2 and the covering 44 may be realized by means of attachments 40. In this case, the covering 44 is manufactured from a transparent or a translucent plastic material. Such a two-dimensional illumination apparatus in conjunction with the radiation unit 22 is able to achieve a very impressive and also effective illumination of the interior garage space. In addition to the two-dimensional illumination, here, it is also possible to additionally employ the light band 3.

FIG. 16 represents a modified embodiment of the illumination apparatus, which is represented in a perspective illustration as the illumination unit 46. Electric energy is supplied from the control unit 26 to the illumination unit 46 via an electric connection 48. Essentially, the illumination unit 46 is distinguished by a planar, two-dimensional radiation surface 45 without any edges. The radiation surface 45 is delimited by a lateral edge 49. For example a communications field 47 may be incorporated within the radiation surface 45, which in addition to displays, may include an electronic push-button field as well.

The basic structure of the illumination unit 46 is represented in an exploded illustration in FIG. 17. The radiation surface 45 is configured with the lateral circumferential borders 49 and the communications field 47 provided in the radiation surface 45 is represented in the lower part. In a first preferred embodiment, it is possible that the radiation surface 45 is connected to a frame 53. The frame 53 is distinguished in that it surrounds the reflector 52. Laterally to the frame 53, at least the radiation unit 43 may be affixed, in which light-emitting diodes are accommodated and connected. By supplying electrical voltage, said non-illustrated light-emitting diodes generate light, which effects a homogenous lighting of the radiation surface 45 by means of the configured reflector 52.

In a further preferred embodiment, it is possible to insert a light guide 50 behind the border 49 of the radiation surface 45. Said light guide 50 may be charged with electric voltage from the radiation unit 43. However, it is likewise possible to employ here an additional radiation unit 51.

The light guide 50 is just located in the exterior area of the border 49, wherein the border 49, just like the entire radiation surface 45, may be transparent, respectively made from a translucent plastic material and thus performs a light output when the light guide 56 is energized. In contrast to the two-dimensional illumination illustrated in the first preferred embodiment, the light guide 50 is employed to illuminate the border area of the illumination unit 46. When appropriately selecting the light-emitting diodes, this may result in different illumination colours, which can be found in different colour spectra. Preferably, the illumination colour of the light guide 56 can be embodied in a blue range. It should be noted that technically any other illumination colour can be realized without any problem.

The illumination unit 46 with or without light guide 50 as one unit may be connected to the upper housing part 32. In this case, the illumination unit 46 represents the lower housing part 2. It is hereby revealed that also other embodiments of the lower housing part 2 can be optionally employed.

FIG. 18 represents a further preferred embodiment of the enclosure of the drive unit 1. In said exemplary embodiment, an upper housing part 54 is so to speak integrally configured, which means that the housing back side 7 does not include a mounting base 5. At the frontal side 17, the extension 10 is again configured such that the drive track 4 is inserted into the extension 10 and immobilized by means of screw connections 20. This may be even more assisted by further attachments 55. Otherwise, the form-shaped configuration of the enclosure is analogously to the preferred embodiment types, which have been described in detail, except for an adjoining area 56 provided at a head side 59. Said adjoining area 56 is covered by a non-illustrated configuration of a closure. Within the adjoining area 56, in addition to a mains connection 58, also the possibility is given to proceed to checking the drive unit 1 via service connections 57. In this preferred embodiment, the upper housing part 54 has been manufactured completely from plastic material or from metal.

FIG. 19 reveals a view into the upper housing part 54. While omitting the Lower housing part 2, it is possible to have a look into the interior side of the upper housing part 54 with the structural components required for the regular use. The drive track 4 is connected to the gearbox 29. In the transverse connection to the gearbox 29, the motors 27, 28 are disposed. Optionally, they may be employed as well individually. The motor connectors 62 build the electrical connection for the motors 27, 28. A transformer 60 is attached via an attachment 63 in the bottom of the upper housing part 54. Furthermore, the control boards 64 and 65 are provided for the control unit 26. The adjoining area 56 with the service connections 57 and the mains connection 58 is located at the head side 59. The upper housing part 54 includes a circumferential border 66, which is suitable to be directly or indirectly connected to the lower housing part 2, respectively to the illumination unit 46. For increasing the stability of the upper housing part 54, the latter includes reinforcing ribs 61.

### REFERENCES NUMERALS

1 drive unit
2 lower housing part
3 light band
4 drive track
5 mounting base
6 adjoining area
7 housing backside
8 rounding
9 lateral sections
10 extension
11 transition
12 drive track lateral part
13 catch member
14 light band
15 border areas
16 extension
17 frontal side
18 adjoining area
19 force transmitting means
20 screw connection
21 slant/rounding
22 attachment
23 lintel attachment
24 connecting lever
25 track attachment
26 control unit
27 motor
28 motor
29 gear
30 drive track attachment
31 attachment
32 upper housing part
33 connection
34 attachment
35 reinforcing ribs
36 reinforcement
37 housing underside
38 linking part
39 exterior side
40 attachment
41 clips connection
42 bottom
43 radiation unit
44 covering
45 radiation surface
46 illumination unit
47 communications field
48 connection
49 border
50 light guide
51 radiation unit
52 reflector
53 frame
54 upper housing part
55 attachment
56 adjoining area
57 service connections
58 mains power supply
59 head side
60 transformer
61 reinforcing ribs
62 motor connection
63 attachment
64 control board
65 control board
66 border

1. An enclosure for a drive unit for the automation of a garage door, wherein the drive unit includes a connection to a drive track, which is provided with revolving force transmitting means, the enclosure, comprising:
a two-part housing having a lower housing part and an upper housing part, wherein the lower housing part includes a straight planar housing underside the border area thereof being provided with roundings and thereto adjoining essentially straight lateral sections, and the upper housing part is fitted onto the lateral sections, wherein the exterior contour includes transitions, which are configured as curved extensions, which merge into a straight housing back side, which is configured substantially parallel to the housing underside, and wherein a surface content of the housing back side is smaller than the surface content of the housing underside.

2. The enclosure according to claim 1, wherein the housing back side includes completely or partially a mounting base, which includes an adjoining area for the drive track, and wherein the drive track is connected in a butt-shape manner to the drive unit at or via a frontal side.

3. The enclosure according to claim 1, wherein the exterior transitions between the individual sections of the enclosure are configured without steps, and the enclosure essentially consists of plastic material, and wherein the housing underside consists of a translucent material, behind which at least one of a substantially two-dimensional illumination apparatus and a circumferential or partially circumferential light band is located.

4. The enclosure according to claim 1, wherein the housing underside includes a rectangular or square shape.

5. The enclosure according to claim 1, wherein the upper housing part includes plastic material and an extension at the frontal side for the reception of the drive track, and wherein the drive track is connected to structural components of at least one of the drive unit and the housing back side.

6. The enclosure according to claim 1, wherein the drive track is laterally equipped with drive track lateral parts, the exterior dimensions thereof in the mounted condition substantially correspond to the width and the thickness of the drive unit and at long sides thereof include respectively one light band.

7. The enclosure according to claim 1, wherein the dimension of the width of the enclosure amounts to a multiple of the height of the drive unit and the surface content of the housing underside is equal to or larger than the surface content of the housing back side.

8. The enclosure according to claim 1, wherein in the area of the mounting base at least one of the drive unit is equipped with attachments and the drive track is equipped with at least one track attachment.

9. The enclosure according to claim 1, wherein in the area of the roundings an essentially circumferential light band is configured behind a translucent covering.

10. The enclosure according to claim 3, wherein at least one of the illumination apparatus is configured as an illumination unit and the light band is closed off by means of a translucent covering made from a single piece or several pieces.

11. The enclosure according to claim 10, wherein the illumination unit includes a light-permeable essentially flat configured radiation surface, behind which a reflector is disposed, which is delimited by a surrounding frame, and wherein a radiation unit, which is disposed in or at the frame, is equipped with light-emitting diodes, which are electrically connected to the drive unit and controlled by means of the electronic control unit thereof.

12. The enclosure according to claim 11, wherein a communications field is associated to the radiation surface.

13. The enclosure according to claim 12, wherein the communications field includes transparent printed electronics with displays and push-buttons which is incorporated into the radiation surface.

14. The enclosure according to claim 11, wherein at least one of the light guide extending within the frame and the number of light-emitting diodes are supplied with energy by means of the radiation unit.

15. The enclosure according to claim 11, wherein the radiation surface is provided with a light guide, which is disposed at an interior side of a surrounding frame, and wherein the light guide is controlled by means of a radiation unit, the illumination colours thereof being in a blue spectral range.

16. The enclosure according to claim 1, wherein the illumination unit is configured from a lower housing part and is removably connected to the upper housing part.

17. The enclosure according to claim 1, wherein the upper housing part includes an adjoining area with service connections, which is accessible from outside and closed by means of a removable cover.

18. The enclosure according to claim 1, wherein at its exterior surfaces, the drive track, which is configured by means of lateral surfaces with cover surfaces adjoined thereto and with an intermediate open area, is equipped with at least one of coloured and decorative surfaces.
